(19) United States
(12) Patent Application Publication
(10) Pub. No.: US 2021/0072737 A1
(43) Pub. Date: Mar. 11, 2021

(54) SYSTEM FOR POWER PLANT MANAGEMENT AND DEVICE FOR BUILDING 3D VIRTUAL MODEL OF POWER PLANT

(71) Applicant: Siemens Aktiengesellschaft, Muenchen (DE)

(72) Inventors: Wei LI, Shanghai (CN); Hai Tao LI, Shanghai (CN); Peng Hui ZHANG, Shanghai (CN); Yu Cheng TANG, Shanghai (CN)

(73) Assignee: Siemens Aktiengesellschaft, Muenchen (DE)

(21) Appl. No.: 16/959,470

(22) PCT Filed: Jan. 10, 2019
(86) PCT No.: PCT/EP2019/050556

§ 371 Date: Jul. 1, 2020

(30) Foreign Application Priority Data
Jan. 11, 2018 (CN) 2018 1 0026619.8

(51) Int. Cl. G05B 19/418; G05B 17/02

(52) U.S. Cl. CPC G05B 19/41885; G05B 17/02

(57) ABSTRACT

A system for power plant management includes: a power plant data module for acquiring equipment data associated with power plant equipment and layout data associated with a plant layout; a database module for building a database according to the acquired equipment data; an unmanned aerial vehicle (UAV) route planning module for creating UAV route planning data, including a UAV route and photographing positions to be performed, according to the layout data; a UAV data acquisition module for acquiring UAV data including power plant images photographed at the photographing positions by a UAV and position data associated with the photographing positions; and a model building module for building a 3D virtual model of the power plant according to the database and the UAV data. The present application improves the experience of a user in managing a power plant and provides an economical power plant management solution.

### PRIORITY STATEMENT

This application is the national phase under 35 U.S.C. § 371 of PCT International Application No. PCT/EP2019/050556 which has an International filing date of Jan. 10, 2019, which designated the United States of America and which claims priority of Chinese Patent Application CN201810026619.8, filed Jan. 11, 2018, the entire contents of each of which are hereby incorporated by reference herein, in the entirety and for all purposes.

### FIELD

The present application generally relates to the field of management of power plants, and in particular, to a system for power plant management and a device for building a 3D virtual model of a power plant.

### BACKGROUND

With the rapid development of information technologies, the management mode of a power plant has changed from manual management to electronic management, and is shifting to a digital management mode with widespread application of digital technologies. Thanks to the development of automation equipment, the inspection for the power plant may rely on the support for the fully manual monitoring of remote videos and manual operations. Data of equipment in a power plant are sent via a running remote data acquisition apparatus to a remote monitoring platform over a network. When the equipment of the power plant is abnormal, the remote monitoring plat form alerts inspection personnel, who can, in turn, inform a technician responsible for the maintenance of the abnormal equipment, so as to maintain the equipment on site to improve the efficiency of equipment maintenance.

For the existing power plant inspection technologies, a large number of cameras are required in order to monitor each position of the power plant in real time. This not only requires a large amount of financial investment, but also generates a large amount of video data, which requires a large amount of manpower for monitoring and makes it difficult to determine the surveillance video that needs attention. Usually, the monitoring may be presented to the inspection personnel in the form of a two-dimensional model or data table of the power plant. However, in this case, it is difficult for the inspection personnel to monitor an actual operation state of the equipment, and the inspection personnel do not know the current actual situation of the equipment, which reduces the efficiency of handling abnormal conditions.

With the development of 3D virtual reality technologies, some power plants are managed in a virtual power plant manner, in which a 3D model of the power plant is first built and such a 3D model may be built manually or built using a design model of the power plant during the design. Either way, due to the complex structure of the power plant, the 3D modeling thereof would take a large amount time and manpower, and this 3D model is different from the current state of the power plant and cannot accurately reflect the actual situation of the power plant. If this solution is adopted, the modeling process will be extremely complex and will slow down the application process of virtual power plant management. So in fact, this solution is only useful for small-scale simulation and training for the personnel, or for marketing or commercial usages, and because the virtual power plant modeling is actually not associated with the actual equipment and environment of the power plant, this solution cannot be used in the actual inspection and operation of the power plant.

In addition, the management personnel cannot know the positions of the inspection personnel or power plant operators during the inspection and field operations by the inspection personnel or power plant operators, and cannot learn about an operating state of the power plant in time, making it difficult to manage the personnel in the power plant.

### SUMMARY

Embodiments of the present application provide a system for power plant management and a device for building a 3D virtual model of a power plant to at least address the problems existing in the prior art that it is difficult to monitor the actual operating state of the equipment, to perform 3D modeling of the entire power plant, and to determine the positions of the personnel.

According to an embodiment of the present application, a system for power plant management is provided, including: a power plant data module for acquiring equipment data associated with power plant equipment in a power plant and layout data associated with a layout of the power plant; a database module for building a database according to the acquired equipment data; an unmanned aerial vehicle (UAV) route planning module for creating UAV route planning data according to the layout data, the UAV route planning data including a UAV route and photographing positions at which photographing needs to be performed; a UAV data acquisition module for acquiring UAV data, the UAV data including power plant images taken at the photographing positions along the UAV route by a UAV and position data associated with the photographing positions; and a model building module for

According to another embodiment of the present application, a device for building a 3D virtual model of a power plant is provided, including: a receiving unit for receiving equipment data associated with power plant equipment in a power plant and layout data associated with a layout of the power plant; a memory for storing the acquired equipment data; a UAV route planning unit for creating UAV route planning data according to the layout data, the UAV route planning data including a UAV route and photographing positions at which photographing needs to be performed; a UAV data acquisition unit for acquiring UAV data, the UAV data including power plant images captured at the photographing positions along the UAV route by a UAV and position data associated with the photographing positions; and a model building unit for building a 3D virtual model of the power plant according to the equipment data and the UAV data.

### BRIEF DESCRIPTION OF THE DRAWINGS

The accompanying drawings described herein are used to provide a further understanding of the present application, and constitute a part of the present application. The illustrative embodiments of the present application and the description thereof are for the explanation of the present application and do not constitute an undue limitation of the present application. In the accompanying drawings:

FIG. 1 is a block diagram of a system for power plant management according to an embodiment of the present application;

FIG. 2 is a block diagram of a system for power plant management according to an example embodiment of the pre sent application;

FIG. 3 is a block diagram of a system for power plant management according to an example embodiment of the pre sent application;

FIG. 4 is a block diagram of a system for power plant management according to an example embodiment of the pre sent application;

FIG. 5 is a block diagram of a system for power plant management according to an example embodiment of the pre sent application;

FIG. 6 is a block diagram of a system for power plant management according to an example embodiment of the pre sent application;

FIG. 7 is a block diagram of a system for power plant management according to an example embodiment of the pre sent application;

FIG. 8 is a block diagram of a system for power plant management according to an example embodiment of the pre sent application; and

FIG. 9 is a block diagram of a device for building a 3D virtual model of a power plant according to an embodiment of the present application.

### LIST OF REFERENCE NUMERALS

Power plant data module 11
Database module 13
UAV route planning module 15
UAV data acquisition module 17
Model building module 19

### DETAILED DESCRIPTION OF EXAMPLE EMBODIMENTS

According to an embodiment of the present application, a system for power plant management is provided, including: a power plant data module for acquiring equipment data associated with power plant equipment in a power plant and layout data associated with a layout of the power plant; a database module for building a database according to the acquired equipment data; an unmanned aerial vehicle (UAV) route planning module for creating UAV route planning data according to the layout data, the UAV route planning data including a UAV route and photographing positions at which photographing needs to be performed; a UAV data acquisition module for acquiring UAV data, the UAV data including power plant images taken at the photographing positions along the UAV route by a UAV and position data associated with the photographing positions; and a model building module for building a 3D virtual model of the power plant according to the database and the UAV data.

In this way, it is possible to conveniently and quickly build the 3D virtual model for the entire power plant, thereby improving the efficiency of system establishment.

Furthermore, the system further includes: a virtual reality module for providing the 3D virtual model to a terminal device for display to a user.

In this way, an intuitive 3D view of the power plant can be provided for the user of the system.

Furthermore, the virtual reality module further includes: a data association module for associating the equipment data with virtual equipment in the 3D virtual model; and an inter face module for providing a virtual interface in the 3D virtual model, the virtual interface including a control panel for displaying the equipment data associated with the virtual equipment.

In this way, the user can determine and identify the equipment in the power plant from the 3D view of the power plant and can conveniently obtain information about the equipment.

Furthermore, the power plant data module further includes: a sensor module for acquiring operating data associated with the power plant equipment; and a data processing module for obtaining an operating state of the power plant equipment according to the operating data, the operating state being configured to be displayed in the control panel.

In this way, the system for power plant management can acquire and display the current state of the equipment for the user.

Furthermore, the virtual reality module further includes: a virtual camera module for providing a movable virtual camera in the 3D virtual model, a virtual view field of the virtual camera in the 3D virtual model being provided to a virtual reality device of the user; and an operation input module for receiving operation commands input by the user, and controlling the movement of the virtual camera in the 3D virtual model as well as the virtual view field.

In this way, the user of the system is able to control a position needing to be observed in the 3D view of the power plant by operation and provide the user with a simulation of an on-site view field.

Furthermore, the system further includes: a position module for providing positions of personnel of the power plant in the 3D virtual model.

In this way, the management personnel can obtain an intuitive representation of the positions of the personnel of the power plant in the power plant and provide an improved management mode.

Furthermore, the equipment data includes equipment operation data, power plant design data and historical data.

In this way, basic information about the power plant and the equipment therein is acquired.

Furthermore, the system further includes: a model modification module for receiving modification data to modify the 3D virtual model of the power plant. In this way, it is possible to improve and maintain the 3D virtual model of the power plant.

Furthermore, the system further includes: a management module for managing user authorities and system configurations of the system.

In this way, system security measures and basic system settings are provided for power plant management.

Furthermore, the terminal device includes a web browser, a mobile phone, and a virtual reality device.

In this way, the user is provided with a remote and intuitive display of the power plant state.

According to another embodiment of the present application, a device for building a 3D virtual model of a power plant is provided, including: a receiving unit for receiving equipment data associated with power plant equipment in a power plant and layout data associated with a layout of the power plant; a memory for storing the acquired equipment data; a UAV route planning unit for creating UAV route planning data according to the layout data, the UAV route planning data including a UAV route and photographing positions at which photographing needs to be performed; a UAV data acquisition unit for acquiring UAV data, the UAV data including power plant images captured at the photographing positions along the UAV route by a UAV and position data associated with the photographing positions; and a model building unit for building a 3D virtual model of the power plant according to the equipment data and the UAV data.

In this way, it is possible to conveniently and quickly build the 3D virtual model for the entire power plant, thereby improving the efficiency of system establishment.

In the existing power plants, only manually built power plant models are used. Virtual reality can only be useful for small-scale training for personnel, simulation of an operating environment or advertising usages. The model building needs a complex work and cannot accurately reflect the complete environment of the power plant, and cannot achieve data association between equipment in the virtual model and actual equipment of the power plant. Likewise, the on-site 3D real-time positions of the personnel cannot be reflected in the system. The technical solutions of the present application address the above technical problems, and provide an improved power plant management solution which can perform 3D modeling on a power plant conveniently, accurately and completely, and associate a model in virtual reality with actual conditions of the power plant and equipment data, thereby providing the management personnel with a view of positions of the personnel in the virtual reality 3D model, achieving convenient and intuitive real-time power plant management, and improving the user experience.

In order to enable a person skilled in the art to better understand the solutions of the present application, the technical solutions in the embodiments of the present application will be clearly and completely described in the following with reference to the accompanying drawings in the embodiments of the present application. Apparently, the described embodiments are merely some of, rather than all of, the embodiments of the present application. All other embodiments obtained by a person of ordinary skill in the art based on the embodiments of the present application without creative efforts should be within the protective scope of the present application.

It needs to be noted that the terms such as “first” and “second” in the description and claims of the present application as well as the aforementioned accompanying drawings are used to distinguish similar objects, and are not necessarily used to describe a specific order of precedence. It is to be understood that the data so used may be interchanged where appropriate, so that the embodiments of the present application described herein can be implemented in a sequence other than those illustrated or described herein. In addition, the terms “include” and “have” and any variations thereof are intended to cover non-exclusive inclusions. For example, a system, product, or device that includes a series of modules or units is not necessarily limited to those modules or units that are explicitly listed, but may include other modules or units not explicitly listed or inherent to such products or devices.

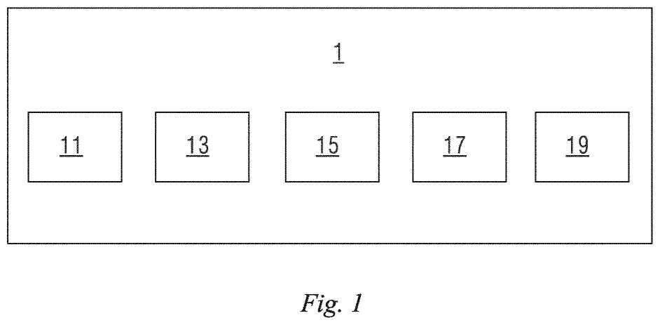

A system 1 for power plant management is provided according to an embodiment of the present application. FIG. 1 is a block diagram of a system for power plant management according to an embodiment of the present application. As shown in FIG. 1, the system 1 includes: a power plant data module 11 for acquiring equipment data associated with power plant equipment in a power plant and layout data associated with a layout of the power plant; a database module 13 for building a database according to the acquired equipment data; a UAV route planning module 15 for creating UAV route planning data according to the layout data, the UAV route planning data including a UAV route and photographing positions at which photographing needs to be performed; a UAV data acquisition module 17 for acquiring UAV data, the UAV data including power plant images captured at the photographing positions along the UAV route by a UAV and position data associated with the photographing positions; and a model building module 19 for building a 3D virtual model of the power plant according to the database and the UAV data.

In this system, the data of the power plant equipment and the layout data of the power plant are received from a distributed control system to obtain basic information about the power plant and the equipment therein, and these pieces of information are all used to build the 3D virtual model of the power plant. The power plant data module 11 acquires data directly from the power plant equipment via an interface, or receives input original design data of the power plant, and the these pieces of data are stored in the database module 13. The database module 13 may include a data archive and a knowledge base library containing basic information about the power plant and the equipment therein. Compared with a conventional manual 3D modeling method, the present application provides a faster modeling method, in which a UAV is used to take images of various positions of the power plant and these images can be processed by software to implement 3D modeling. The system 1 includes the UAV route planning module 15 that provides a flight route for the UAV to take the images of the power plant, so as to plan (e.g., by a route algorithm) a route at which photographing needs to be performed, and the route includes one or more positions at which photographing needs to be performed, so that the UAV takes images for the targets to be photographed at desired angles in the power plant while the UAV passes through these photographing positions along the photographing route, to obtain image data for 3D modeling. The UAV can carry a device capable of taking high-definition images to provide accurate modeling data for 3D modeling. Moreover, the UAV can reach areas that are not reachable for personnel, thereby facilitating the photo graphing of the various positions of the power plant, to obtain images of various actual desired positions and angles in the power plant. The UAV data acquisition module 17 acquires the image data taken by the UAV and the position data associated with the images taken by the UAV, such as GPS geographic position coordinates, such that the specific positions and the image data can be associated during modeling. The model building module 19 builds the 3D virtual model based on the data, for example, by processing the image data, creating 3D image points in 3D model coordinates for the photographed targets in the images, and generating the corresponding positions in the 3D virtual model in combination with the position data. The images taken by the UAV at various angles can also be used to conveniently remove unwanted objects there from during the 3D modeling, identify and generate models for targets of interest in the power plant management and generate models. In addition, the model building module 19 creates a triangular mesh for a target in the 3D virtual model to establish a 3D model of the target, and can create a map for the 3D model of the target, for example, in combination with the captured image data, to obtain an immersive 3D model of the target. In this way, according to the data and position information of the power plant and equipment in the database, 3D modeling can be quickly performed on the power plant upon the obtaining of the image data by the UAV in accordance with the route and the photographing positions. This method can also be applied to 3D modeling inside a building of the power plant.

In this way, it is possible to conveniently and quickly build the 3D virtual model for the entire power plant, thereby improving the efficiency of system establishment. Meanwhile, a large amount manpower required for 3D modeling work and thus system investment is saved.

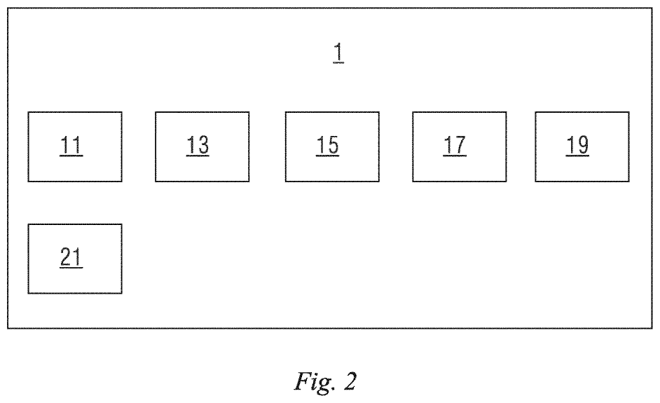

FIG. 2 is a block diagram of a system for power plant management according to an example embodiment of the pre sent application. As shown in FIG. 2, according to an example embodiment of the present application, the system 1 further includes: a virtual reality module 21 for providing the 3D virtual model to a terminal device for display to a user. The user can obtain the display of the 3D virtual model of the power plant through the display of the terminal de vice, thereby obtaining an intuitive understanding of the actual overall environment of the power plant. Moreover, the user can remotely obtain a view of the power plant through the terminal device, and for example, can transmit data of the views through a wireless network. The 3D virtual model provided by the virtual reality module 21 provides the user with a virtual reality experience.

In this way, an intuitive 3D view of the power plant can be provided for the user of the system.

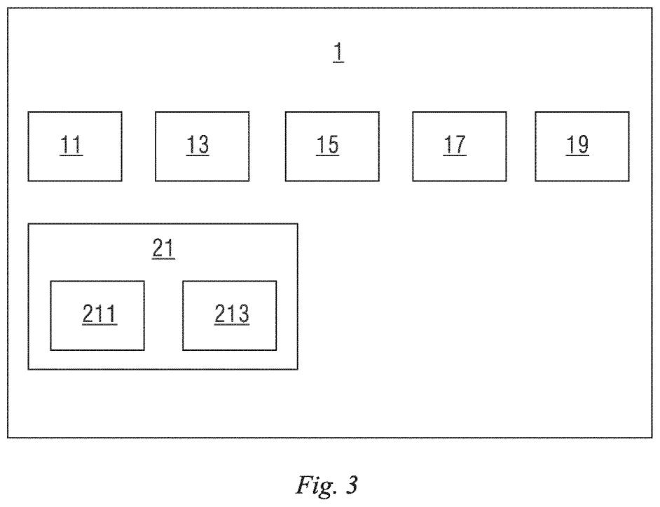

FIG. 3 is a block diagram of a system for power plant management according to an example embodiment of the pre sent application. As shown in FIG. 3, according to an example embodiment of the present application, the virtual reality module 21 further includes: a data association module 211 for associating the equipment data with a virtual equipment in the 3D virtual model; and an interface module 213 for providing a virtual interface in the 3D virtual model, the virtual interface including a control panel for displaying the equipment data associated with the virtual equipment. For example, after the data association module 211 associates the equipment in the power plant with the corresponding virtual equipment in the 3D virtual model, the interface module 213 can set a label for the virtual equipment in the 3D virtual model corresponding to the equipment in the power plant, or the interface module 213 can provide the control panel in the 3D virtual model, in which more detailed information can be provided, for example, basic information about the equipment, including the equipment number, position, equipment name, type, working time, and more other related information, such as information in a 3D virtual model environment can be provided. When the user browses the 3D virtual model of the power plant in a virtual reality manner, the user can easily determine the seen equipment and learn about the state of the equipment in reality and the information about the virtual model.

In this way, the user can determine and identify the equipment in the power plant from the 3D view of the power plant and can conveniently obtain information about the equipment.

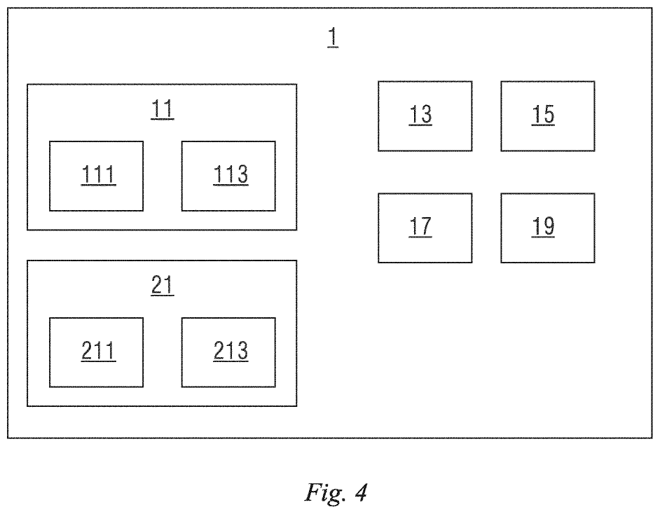

FIG. 4 is a block diagram of a system for power plant management according to an example embodiment of the pre sent application. As shown in FIG. 4, according to an example embodiment of the present application, the power plant data module 11 further includes: a sensor module 111 for acquiring operating data associated with the power plant equipment; and a data processing module 113 for obtaining an operating state of the power plant equipment according to the operating data, the operating state configured to be displayed in the control panel. The system for power plant management can present, in the 3D virtual model, a current state of the equipment in the power plant. The power plant data module 11 includes: the sensor module 111, wherein the sensor module 111 may include one or more sensors that receive operating data, such as operating parameters of the equipment and various state values of the equipment from the equipment of the power plant; and the data processing module 113 which processes these pieces of data to obtain the results of processing and analysis of the operating state of the equipment, wherein the result data can be presented to the user in the control panel in the 3D virtual model for reflecting the operating state of the equipment in the power plant.

In this way, the system for power plant management can acquire and display the current state of the equipment for the user.

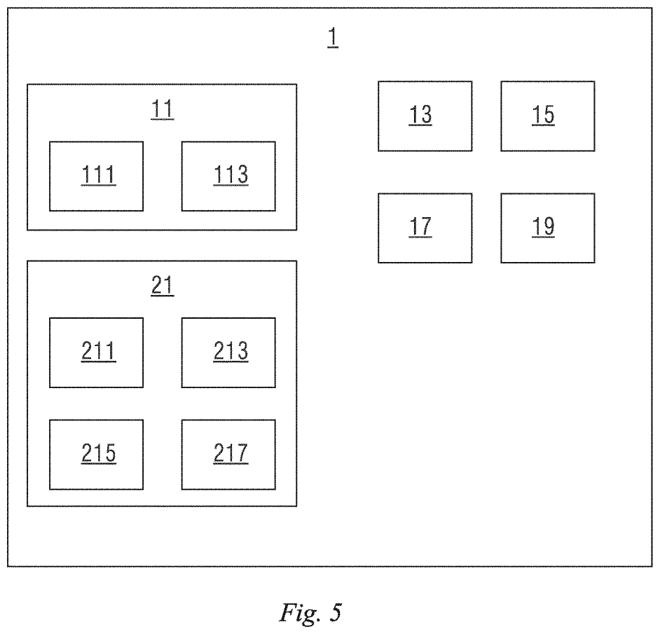

FIG. 5 is a block diagram of a system for power plant management according to an example embodiment of the pre sent application. As shown in FIG. 5, according to an example embodiment of the present application, the virtual reality module 21 further includes: a virtual camera module 215 for providing a movable virtual camera in the 3D virtual model, a virtual view field of the virtual camera in the 3D virtual model being provided to a virtual reality device of the user; and an operation input module 217 for receiving operation commands input by the user, and controlling the movement of the virtual camera in the 3D virtual model and the virtual view field. The system for power plant management provided in the present application provides the user with the view fields of the positions in the 3D virtual model of the power plant that need to be observed, and the virtual camera in the 3D virtual model is provided by the virtual camera module 215 included in the virtual reality module 21, the virtual view field of the virtual camera being the view field obtained by the user during the observation of the 3D virtual model, wherein the view field can be varied according to the movement of the virtual camera in the 3D virtual model, so that the view field can be moved to a suitable position for any target in the 3D virtual model, and the target can be observed at a desired angle. The virtual camera can be controlled by the user, and the operation input module 217 receives the user's control over the virtual camera, for example, the user moves the virtual camera according to the user intention through input commands of an apparatus, such as a joystick, a terminal touch screen, and a virtual reality helmet, to obtain the view field desired by the user and understand the current operating state and information of the power plant equipment.

In this way, the user of the system is able to control a position needing to be observed in the 3D view of the power plant by operation and provide the user with a simulation of an on-site view field. The user can operate and manage more accurately based on the acquired images.

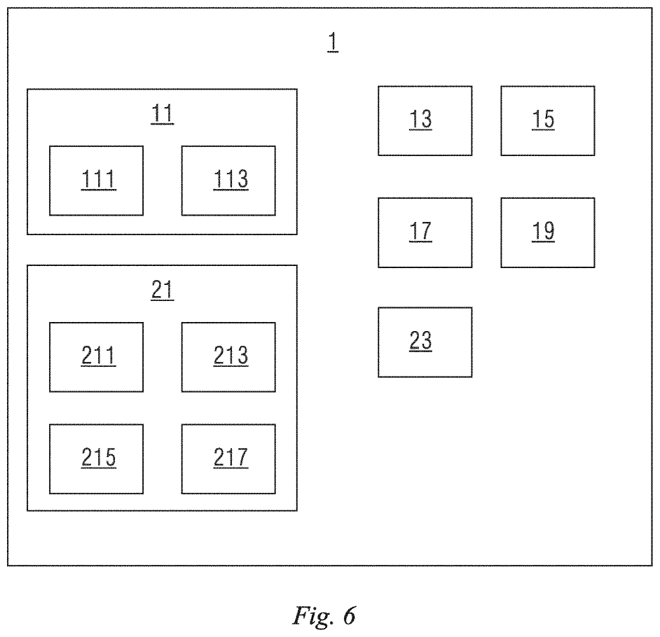

FIG. 6 is a block diagram of a system for power plant management according to an example embodiment of the pre sent application. As shown in FIG. 6, according to an example embodiment of the present application, the system 1 further includes: a position module 23 for providing positions of the personnel of the power plant in the 3D virtual model. The position module 23 can acquire the positions of the personnel of the power plant and provide the display in the 3D virtual model. For example, the power plant personnel may carry a positioning apparatus, and the position module 23 calculates, according to position data sent from the positioning apparatus, corresponding position coordinates of the personnel of the power plant in the 3D virtual model of the power plant, for display in the 3D virtual model. The position information can be obtained in other ways, such as by monitoring photographing or UAV instant photographing.

In this way, the management personnel can obtain an intuitive representation of the positions of the personnel of the power plant in the power plant and provide an improved management mode. The position of the equipment and the positions of the personnel, etc., are displayed in an integrated plat form provided in the present application. When an abnormal situation occurs, the management personnel can know the positions of the on-site personnel in the power plant, and can also obtain the position of the abnormal equipment, thereby facilitating the dispatch of personnel and the monitoring of the real-time positions of the personnel.

According to an example embodiment of the present application, the equipment data includes equipment operation data, power plant design data and historical data. These pieces of data reflect information such as an initial design of the power plant, a current state of the power plant, and a state of the equipment, thereby providing the basic information during modeling and power plant management. Other information about the power plant and the equipment can also be obtained as needed.

In this way, basic information about the power plant and the equipment therein is acquired.

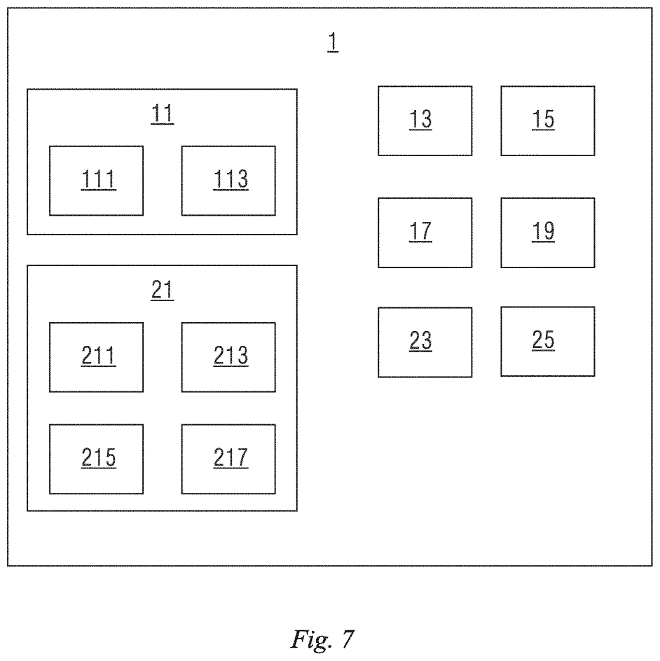

FIG. 7 is a block diagram of a system for power plant management according to an example embodiment of the pre sent application. As shown in FIG. 7, according to an example embodiment of the present application, the system 1 further includes: a model modification module 25 for receiving modification data to modify the 3D virtual model of the power plant. During the above building process of the 3D virtual model, in order to enhance the accuracy of the modeling and avoid problems caused by the number and quality of images and the software for modeling, the model modification module 25 provides a function of modifying the 3D virtual model of the power plant, in which the 3D virtual model can be manually adjusted, or after modeling, additional modeling data (such as the image data, the position data, and the basic information about the equipment, or other suitable data) can be input to the current modeling to refine the 3D virtual model.

In this way, it is possible to improve and maintain the 3D virtual model of the power plant.

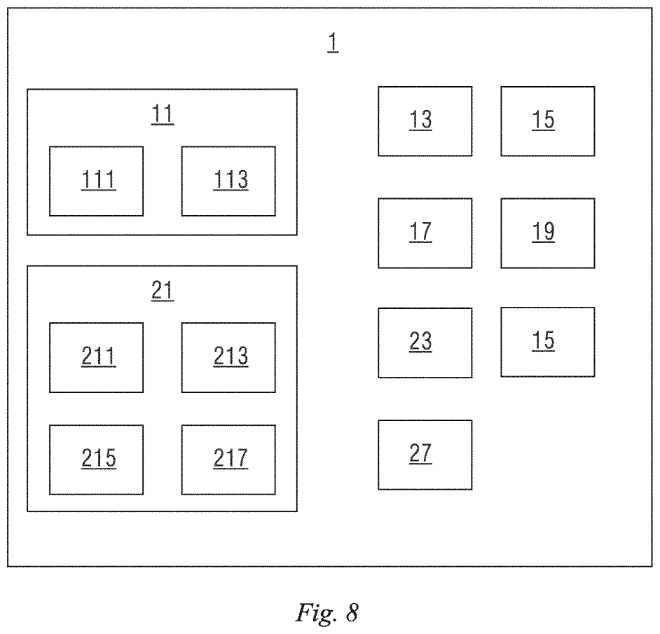

FIG. 8 is a block diagram of a system for power plant management according to an example embodiment of the pre sent application. As shown in FIG. 8, according to an example embodiment of the present application, the system 1 further includes: a management module 27 for managing user authorities and system configurations of the system. For the system for power plant management, the user authorities can be set so as to ensure that, for personnel of a corresponding authority level, the data of the corresponding authority is provided, corresponding views are displayed and corresponding operation permissions are provided. The management module 27 also provides the setting of the system 1, so that the system 1 operates according to the needs of the user configuration.

In this way, system security measures and basic system settings are provided for power plant management.

According to an example embodiment of the present application, the terminal device includes a web browser, a mobile phone, and a virtual reality device. The 3D virtual model of the power plant can be remotely provided to the user, and the user can view the 3D virtual model in various ways and perform inspections on the power plant in the 3D virtual model. The user can enter, via the web browser, a display screen provided by the system, and control the virtual camera via an input device such as a keyboard or a mouse. The 3D virtual model can also be presented via a screen of the mobile phone, and the user controls the view field in the 3D virtual model via the keyboard of the mobile phone. It is also possible to provide a display of the 3D virtual model in more immersive manner via the virtual reality device. For example, the user can control the movement and the view field in the 3D virtual model via a virtual reality helmet, via a virtual display handle, a joystick, etc., so that a roaming experience of inspection is provided, and areas of interest can be observed freely and quickly.

In this way, the user is provided with a remote and intuitive display of the power plant state.

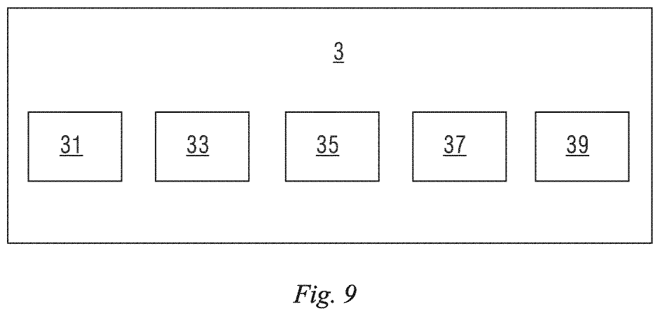

FIG. 9 is a block diagram of a device for building a 3D virtual model of a power plant according to an embodiment of the present application. As shown in FIG. 9, the device 3 for building a 3D virtual model of a power plant according to the embodiment of the present application includes: a receiving unit 31 for receiving equipment data associated with power plant equipment in a power plant and layout data associated with a layout of the power plant; a memory 33 for storing the acquired equipment data; a UAV route planning unit 35 for creating UAV route planning data according to the layout data, the UAV route planning data including a UAV route and photographing positions at which photographing needs to be performed; a UAV data acquisition unit 37 for acquiring UAV data, the UAV including power plant images captured at the photographing positions along the UAV route by a UAV and position data associated with the photographing positions; and a model building unit 39 for building a 3D virtual model of the power plant according to the equipment data and the UAV data. The operation mode of the device is similar to that of the system 1 for power plant management described above, and will not be repeated here.

In this way, it is possible to conveniently and quickly build the 3D virtual model for the entire power plant, thereby improving the efficiency of system establishment. Meanwhile, a large amount manpower required for 3D modeling work and thus system investment is saved.

The technical solutions provided in the present application provide an immersive presentation of the power plant environment for the user (such as the power plant inspection personnel or management personnel), and the user can quickly move to an area that needs to be observed or inspected to obtain information about this area, which improves the efficiency of dealing with an abnormal state. The modeling of the power plant is performed by the adopting UAV photography in combination with the basic information about the power plant, so that the financial investment and modeling time are greatly reduced. With the virtual reality technologies and positioning apparatuses, the management personnel can intuitively manage the personnel of the power plant, so as to be able to make decisions and give operational instructions more quickly when encountering emergencies. This technical solution improves the experience of the user in managing the power plant and provides the user with more satisfactory management functions, while providing an economical power plant management solution.

In the above embodiments of the present application, the various embodiments have described in different emphases, and the portions that are not detailed in a certain embodiment may be considered with respect to the related descriptions of other embodiments. In several embodiments provided by the present application, it should be understood that the disclosed technical content may be implemented in other manners. The apparatus embodiments described above are merely schematic. For example, the division of the units or modules is only a logical function division, and in actual implementations, there may be another division manner. For example, multiple units or modules or components may be combined or integrated into another system, or some features may be omitted or not implemented. In addition, the mutual coupling or direct coupling or communication connection shown or discussed may be an in direct coupling or communication connection through some interfaces, modules or units, and may be electrical or otherwise.

The units or modules described as separate components may or may not be physically separated, and the components dis played as units or modules may or may not be physical units or modules, that is, the components may be located in one place, or may be distributed on multiple network units or modules. Some or all of the units or modules may be selected according to actual needs to achieve the objective of the solution of the embodiment.

In addition, each functional unit or module in various embodiments of the present application may be integrated into one processing unit or module, or each unit or module may be physically present separately, or two or more units or modules may be integrated into one unit or module. The above integrated unit or module can be implemented in the form of hardware or in the form of a software functional unit or module.

The integrated unit, if implemented in the form of a software functional unit and sold or used as an independent product, may be stored in a computer readable storage medium. Based on such understanding, the technical solution of the present application, in essence or the contribution to the prior art, or all or part of the technical solution may be embodied in the form of a software product. The computer software product is stored in a storage medium, and includes a plurality of instructions used to cause a computer device (which may be a personal computer, a server, or a network de vice, etc.) to perform all or part of the steps of the method described in various embodiments of the present application. The foregoing storage medium includes a USB flash disk, a read-only memory (ROM), a random access memory (RAM), a mobile hard disk, a magnetic disk, or an optical disc, and the like, which can store program codes.

The above descriptions are only preferred embodiments of the present application, and it should be noted that a person of ordinary skill in the art can also make several improvements and modifications without departing from the principle of the present application, and these improvements and modifications should also be considered to be within the protection scope of the present application.

1. A system for power plant management, comprising:
a power plant data module to acquire equipment data associated with power plant equipment in a power plant and layout data associated with a layout of the power plant;
a database module to build a database according to the equipment data acquired;
an unmanned aerial vehicle (UAV) route planning module to create UAV route planning data according to the layout data acquired, the UAV route planning data including a UAV route and photographing positions at which photographing needs to be performed;
a UAV data acquisition module to acquire UAV data, the UAV data including power plant images photographed at the photographing positions along the UAV route by a UAV and position data associated with the photographing positions; and
a model building module to build a 3D virtual model of the power plant according to the database built and the UAV data acquired.

2. The system of claim 1, further comprising:
a virtual reality module to provide the 3D virtual model built to a terminal device for display to a user.

3. The system of claim 2, wherein the virtual reality module further comprises:
a data association module to associate the equipment data acquired with virtual equipment in the 3D virtual model built; and
an interface module to provide a virtual interface in the 3D virtual model built, the virtual interface including a control panel to display the equipment data associated with the virtual equipment.

4. The system of claim 3, wherein the power plant data module further comprises:
a sensor module to acquire operating data associated with the power plant equipment; and
a data processing module to obtain an operating state of the power plant equipment according to the operating data acquired, the operating state being configured to be displayed in the control panel.

5. The system of claim 2, wherein the virtual reality module further comprises:
a virtual camera module to provide a movable virtual camera in the 3D virtual model, a virtual view of the movable virtual camera in the 3D virtual model being provided to a virtual reality device of the user; and
an operation input module to receive operation commands input by the user, and to control movement of the virtual camera in the 3D virtual model and in the virtual view.

6. The system of claim 2, further comprising: a position module to provide positions of personnel of the power plant in the 3D virtual model.

7. The system of claim 1, wherein the equipment data comprises equipment operation data, power plant design data and historical data.

8. The system of claim 1, further comprising:
a model modification module to receive modification data to modify the 3D virtual model of the power plant.

9. The system of claim 1, further comprising:
a management module to manage user authorities and system configurations of the system.

10. The system of claim 2, wherein the terminal device includes a web browser, a mobile phone, and the virtual reality module.

11. A device for building a 3D virtual model of a power plant, comprising:
a receiver to receive equipment data associated with power plant equipment in the power plant and layout data associated with a layout of the power plant;
a memory to store the equipment data acquired;
an unmanned aerial vehicle (UAV) route planning device to create UAV route planning data according to the layout data received, the UAV route planning data including a UAV route and photographing positions at which photographing needs to be performed;
a UAV data acquisition device to acquire UAV data, the UAV data including power plant images photographed at the photographing positions along the UAV route by a UAV and position data associated with the photographing positions; and
a model building device to build a 3D virtual model of the power plant according to the equipment data received and the UAV data acquired.

12. A device for building a 3D virtual model of a power plant, comprising:
a receiver to receive equipment data associated with power plant equipment in the power plant and layout data associated with a layout of the power plant;
a memory to store the equipment data acquired;
at least one processor to
create UAV route planning data according to the layout data received, the UAV route planning data including a UAV route and photographing positions at which photographing needs to be performed;
acquire UAV data, the UAV data including power plant images photographed at the photographing positions along the UAV route by a UAV and position data associated with the photographing positions; and
build a 3D virtual model of the power plant according to the equipment data received and the UAV data acquired.

13. The device of claim 12, wherein the at least one processor is further configured to
provide the 3D virtual model built to a terminal device for display to a user.

14. The device of claim 13, wherein the at least one processor is further configured to associate the equipment data acquired with virtual equipment in the 3D virtual model built; and the device further comprising:
a control panel to display the equipment data associated with the virtual equipment, on a virtual interface in the 3D virtual model built.

15. The device of claim 14, further comprising:
a sensor to acquire operating data associated with the power plant equipment; wherein the at least one processor is further configured to:
obtain an operating state of the power plant equipment according to the operating data acquired, the operating state being configured to be displayed in the control panel.
